(19) United States
(12) Patent Application Publication
(10) Pub. No.: US 2025/0157187 A1
(43) Pub. Date: May 15, 2025

(54) IMAGE LEARNING MODEL

(71) Applicant: Netflix, Inc., Los Gatos, CA (US)

(72) Inventors: Aneesh Vartakavi, Fremont, CA (US); Dong Liu, San Jose, CA (US); Benjamin Eliot Klein, San Francisco, CA (US)

(21) Appl. No.: 18/506,881

(22) Filed: Nov. 10, 2023

(51) Int. Cl. G06V 10/74; G06T 11/60

(52) U.S. Cl. CPC G06V 10/761; G06T 11/60

(57) ABSTRACT

A computer-implemented method may include accessing an image associated with a media item and identifying an association between the accessed image and an image take fraction that indicates how well the accessed image correlates to views of the associated media item. Then, based on the identified association between the accessed media item image and the corresponding image take fraction, the method may include training a machine learning (ML) model to predict which images will optimally correlate to views of the associated media item. The method may further include accessing an unprocessed image associated with a new media item that has not been processed by the trained ML model and implementing the trained ML model to predict an image take fraction for the unprocessed image to indicate how well the unprocessed image will correlate to views of the new, unprocessed media item. Various other methods, systems, and computer-readable media are also disclosed.

### BACKGROUND

Movies and other media items often have box art, billboards, and other types of artwork associated with them. This artwork typically serves to entice people to view the corresponding media item. The box art, for example, is often positioned as the icon image in a lineup of media items in a streaming service, or on the cover of a digital video disc (DVD) or other physical media. In many instances, designers or other artists will attempt to craft a box art image that conveys information about the media item (e.g., a movie), including which actors or actresses are in the movie, which genre the movie falls into, who directed the movie, or other similar information. In some cases, still images from the movie are selected to function as box art. However, each movie or tv show may include thousands of different images, each of which may have a different appeal to potential audiences. The sheer amount and different types of available images may overwhelm human users that are tasked with trying to identify box art images from a broad range of available images.

### SUMMARY

As will be described in greater detail below, the present disclosure describes systems and methods for predicting image performance for media item images and their corresponding media items.

In some embodiments, the techniques described herein relate to a computer-implemented method that may include: accessing at least one image associated with a media item, identifying an association between the accessed image and an image take fraction that indicates how well the accessed image correlates to views of the associated media item. Then, based at least on the identified association between the accessed media item image and the corresponding image take fraction, the method may include training a machine learning (ML) model to predict which images will optimally correlate to views of the associated media item. Still further, the method may include accessing an unprocessed image associated with a new media item that has not been processed by the trained ML model, and then implementing the trained ML model to predict an image take fraction for the unprocessed image to indicate how well the unprocessed image will correlate to views of the new, unprocessed media item.

In some cases, the ML model may be configured to identify one or more patterns in the unprocessed image and match those identified patterns to patterns associated with the accessed image. In some embodiments, the computer-implemented method may further include filtering images that are to be processed by the ML model to ensure that the images are usable by the ML model. In some examples, the image take fraction may indicate a percentage of views of the associated media item relative to a number of impressions of the accessed image.

In some cases, the ML model may include a deep learning model that is configured to analyze a plurality of images and a corresponding plurality of image take fractions to indicate how well the plurality of images correlates to views of the associated media items. In some embodiments, the computer-implemented method may further include ranking each of the plurality of images based on the predicted image take fractions. In some examples, the image take fraction may include, as a factor, an amount of time spent watching the media item. In other cases, the image take fraction may include, as a factor, a genre associated with the media item.

In some embodiments, different versions of an accessed image may result in different image take fractions for the associated media item. For instance, these versions may include different aesthetics or different framing. In some examples, recropped versions of the accessed image may result in different image take fractions for the associated media item. In some cases, the ML model may be configured to process the recropped versions of the accessed image as separate images that are each associated with the media item. In some embodiments, the computer-implemented method may further include tracking, as feedback, how well the unprocessed image correlated to views of the associated media item, and incorporating the feedback in the ML model when accessing future images and predicting future image take fractions. In some cases, the computer-implemented method may further include changing an artwork image for at least one media item based on the incorporated feedback.

In some aspects, the techniques described herein relate to a system including: at least one physical processor and physical memory including computer-executable instructions that, when executed by the physical processor, cause the physical processor to: access at least one image associated with a media item, identify an association between the accessed image and an image take fraction that indicates how well the accessed image correlates to views of the associated media item, based at least on the identified association between the accessed media item image and the corresponding image take fraction, train a machine learning (ML) model to predict which images will optimally correlate to views of the associated media item, access an unprocessed image associated with a new media item that has not been processed by the trained ML model, and implement the trained ML model to predict an image take fraction for the unprocessed image to indicate how well the unprocessed image will correlate to views of the new, unprocessed media item.

In some cases, the unprocessed image and other images processed by the ML model are ranked based on the corresponding predicted image take fractions, and wherein a supervised model is implemented to group the ranked images into thematic containers. In some examples, each thematic bucket may be assigned a specific number of images that are to be taken from the associated media item and placed in each thematic container.

In some embodiments, the thematic containers may include containers for at least one of: images with specific characters, images conveying specific genres, images conveying specific storylines, images conveying specific tones, images intended for a specific audience, or images conveying a specific type of shot. In some cases, at least one of the images may belong to a plurality of different thematic containers. In some cases, the images in each thematic container may be ranked based on the image's corresponding image take fraction. In some embodiments, the processor of the system may further present the images in the thematic containers to at least one user for selection and use with the associated media item.

In some aspects, the techniques described herein relate to a non-transitory computer-readable medium including one or more computer-executable instructions that, when executed by at least one processor of a computing device, cause the computing device to: access at least one image associated with a media item, identify an association between the accessed image and an image take fraction that indicates how well the accessed image correlates to views of the associated media item, based at least on the identified association between the accessed media item image and the corresponding image take fraction, train a machine learning (ML) model to predict which images will optimally correlate to views of the associated media item, access an unprocessed image associated with a new media item that has not been processed by the trained ML model, and implement the trained ML model to predict an image take fraction for the unprocessed image to indicate how well the unprocessed image will correlate to views of the new, unprocessed media item.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates a computing architecture in which embodiments of the disclosure may be performed.

FIG. 2 illustrates a flow diagram of a method for predicting image performance for media item images and their underlying media items.

FIG. 3 illustrates an alternative computing architecture in which embodiments of the disclosure may be performed including retrieving, ranking, and diversifying images.

FIG. 4 illustrates an alternative computing architecture in which embodiments of the disclosure may be performed including retrieving, ranking, diversifying, and selecting images for implementation in a graphical user interface.

FIG. 5 illustrates a computing architecture in which embodiments of the disclosure may be performed including retrieving images from a media item.

FIG. 6 illustrates a computing architecture in which embodiments of the disclosure may be performed including ranking images from a media item.

FIG. 7 illustrates a computing architecture in which embodiments of the disclosure may be performed including calculating an image take fraction.

FIG. 8 illustrates a computing architecture in which embodiments of the disclosure may be performed including ranking images from a media item.

FIG. 9 illustrates a computing architecture in which embodiments of the disclosure may be performed including diversifying ranked images.

FIG. 10 illustrates an alternative computing architecture in which embodiments of the disclosure may be performed including diversifying ranked images.

FIG. 11 illustrates an embodiment of different example thematic containers for images associated with a media item.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to predicting image performance for media item images and their corresponding media items. As noted above, box art images are often taken from media items such as movies to represent those movies. For instance, a movie that stars a current A-list actor or actress may use a still image of that actor or actress from within the movie to advertise that movie. These images are intended to attract viewers to a movie theater or to click “play” on a title within a media streaming service. These images may be implemented in movie posters, billboards, streaming service selection menus, or in other locations.

In some cases, for example, in video streaming services, these images may be referred to as “storyart images,” and may include any type of artwork used to attract a user to a given media item and ultimately entice the user to watch the media item. The number of times a given title is played is often referred to as the number of “views” the media item has received. Storyart is typically selected or intentionally designed to increase the number of views associated with a given title. Historically, however, human users who select the storyart images used with media items may struggle with the overwhelming number of images available, as well as the different types of images that may appeal to different audiences.

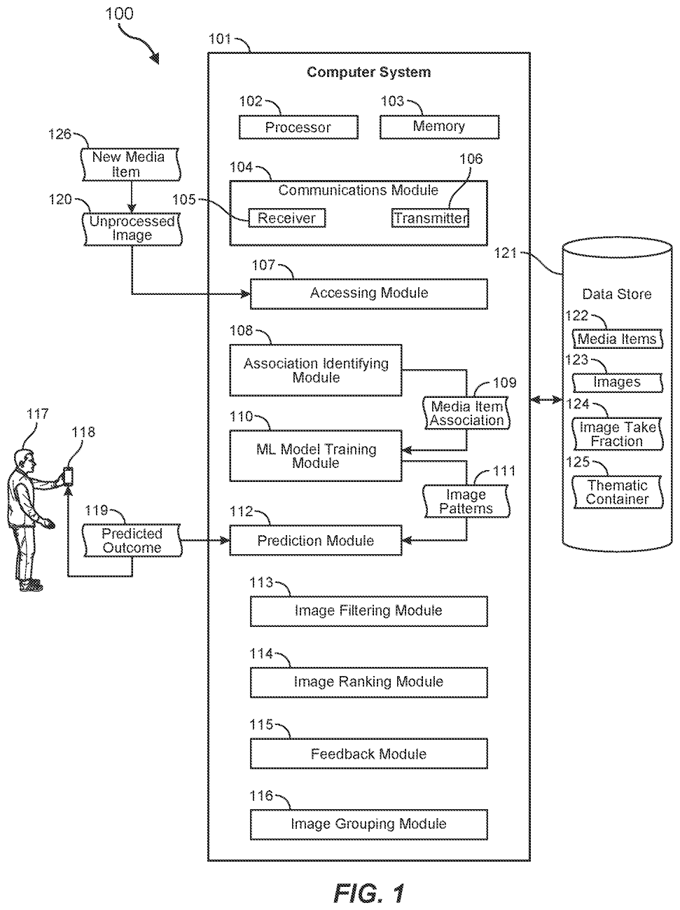

The embodiments described herein present systems and methods that have been shown to empirically increase the number of views for a given media item. As will be explained in greater detail below, these systems and methods may implement multiple different techniques, either alone or in combination, to create or select better storyart that drives increased views to the storyart's underlying media item. These systems and methods may, at a high level, filter and retrieve images that are suitable for display as storyart, may identify patterns in the retrieved images to rank those images based on which is most likely to increase the number of views of the associated media item, and may diversify the ranked images into different thematic containers to provide multiple storyart options for each corresponding media item. While many of the embodiments described herein will reference movies and storyart, it will be understood that the principles, systems, and algorithms described herein may be implemented to extract, rank, and categorize images in substantially any context where images of any type are to be identified and selected for a specific purpose. These embodiments will be described in greater detail below with regard to FIGS. 1-11.

FIG. 1, for example, illustrates a computing environment 100 in which specified images may be identified and used as storyart for a corresponding media item. FIG. 1 includes various electronic components and elements including a computer system 101 that is used, alone or in combination with other computer systems, to perform associated tasks. The computer system 101 may be substantially any type of computer system including a local computer system or a distributed (e.g., cloud) computer system. The computer system 101 includes at least one processor 102 and at least some system memory 103. The computer system 101 includes program modules for performing a variety of different functions. The program modules may be hardware-based, software-based, or may include a combination of hardware and software. Each program module uses computing hardware and/or software to perform specified functions, including those described herein below.

In some cases, the communications module 104 is configured to communicate with other computer systems. The communications module 104 includes substantially any wired or wireless communication means that can receive and/or transmit data to or from other computer systems. These communication means include, for example, hardware radios such as a hardware-based receiver 105, a hardware-based transmitter 106, or a combined hardware-based transceiver capable of both receiving and transmitting data. The radios may be WIFI radios, cellular radios, Bluetooth radios, global positioning system (GPS) radios, or other types of radios. The communications module 104 is configured to interact with databases, mobile computing devices (such as mobile phones or tablets), embedded computing systems, or other types of computing systems.

The computer system 101 further includes an accessing module 107. The accessing module may be configured to access media items 122 including movies, television shows, online videos, or other types of media items. Each of these media items 122 may include corresponding images 123. The images 123 may represent still shots from a movie, for example. In some cases, the images 123 stored in data store 121 may have already been processed and may be stored for later use. The unprocessed images 120 may be images from a new media item 126 that has not yet been processed by the computer system 101.

The computer system 101 may also include an association identifying module 108. The association identifying module 108 may be configured to identify associations between media items 122 and their corresponding images 123. In some cases, the images 123 may be storyart (or may be intended as storyart) for the corresponding media items 122. In such cases, the association identifying module 108 may identify associations between the images and an image take fraction 124 that indicates how well the images correlate to views of the associated media item 122. The “image take fraction,” as the term is used herein, may represent the number of successful streams of a media item relative to the number of impressions of that media item (e.g., the number of people that select the media item in relation to the number of people that see the storyart image). Additionally or alternatively, the image take fraction may indicate the number of users that “liked” the media item (or otherwise indicated interest in the media item) relative to the number of impressions. The higher the ratio in the image take fraction 124, the better the image is at drawing views. The data store 121 may store many thousands or millions of images (or more), along with corresponding image take fractions 124, for each image/media item pair, indicating how well the image performed at drawing views to the media item from which the image was taken.

Computer system 101 may further include a machine learning (ML) model training module 110. The ML model training module 110 may be configured to train an ML model to identify images that are likely to perform well in drawing users to view a given media item. The

ML model may take, as input, the stored media items 122 and their corresponding still images 123, along with any associations 109 between the media item and the corresponding image (e.g., an image take fraction that indicates an image's performance at driving views of the media item). As will be explained further below, the ML model may analyze many, many thousands or millions of images and associated media items and may isolate patterns in images that performed well in driving views for their underlying media items. These image patterns 111 may indicate that a given image will or will not be a good storyart image or, stated differently, that an image will or will not have a high image take fraction 124 relative to its underlying media item 122.

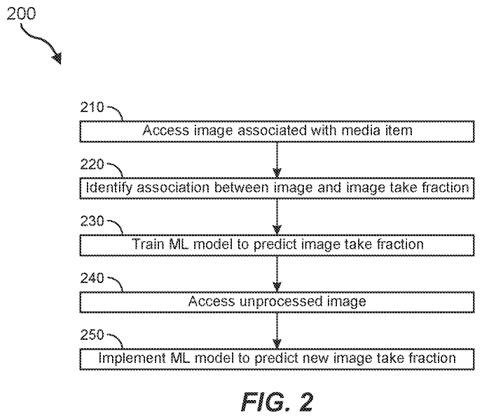

The prediction module 112 of computer system 101 may implement the trained ML model to generate a predicted outcome 119 such as a predicted image take fraction 124. This predicted outcome 119 may be provided to a user 117, to a user's electronic device 118, and/or to other entities. The prediction may specify, for a new, unprocessed image 120 that has not previously been processed by the trained ML model, the most likely image take fraction for that image and the new media item 126. These and other embodiments will be described in greater detail below with regard to Method 200 of FIG. 2 and with continued reference to computing architecture 100 of FIG. 1.

FIG. 2 is a flow diagram of an exemplary computer-implemented method 200 for predicting image performance for media item images and their underlying media items. The steps shown in FIG. 2 may be performed by any suitable computer-executable code and/or computing system, including the system illustrated in FIG. 1. In one example, each of the steps shown in FIG. 2 may represent an algorithm whose structure includes and/or is represented by multiple sub-steps, examples of which will be provided in greater detail below.

As illustrated in FIG. 2, at step 210, the method 200 may include accessing at least one image associated with a media item. At step 220, the method 200 may include identifying an association between the accessed image and an image take fraction that indicates how well the accessed image correlates to views of the associated media item. Then, step 230 may include training an ML model, based at least on the identified association between the accessed media item image and the corresponding image take fraction, to predict which images will optimally correlate to views of the associated media item. Step 240 of method 200 may include accessing an unprocessed image associated with a new media item that has not been processed by the trained ML model and, at step 250, implementing the trained ML model to predict an image take fraction for the unprocessed image to indicate how well the unprocessed image will correlate to views of the new, unprocessed media item.

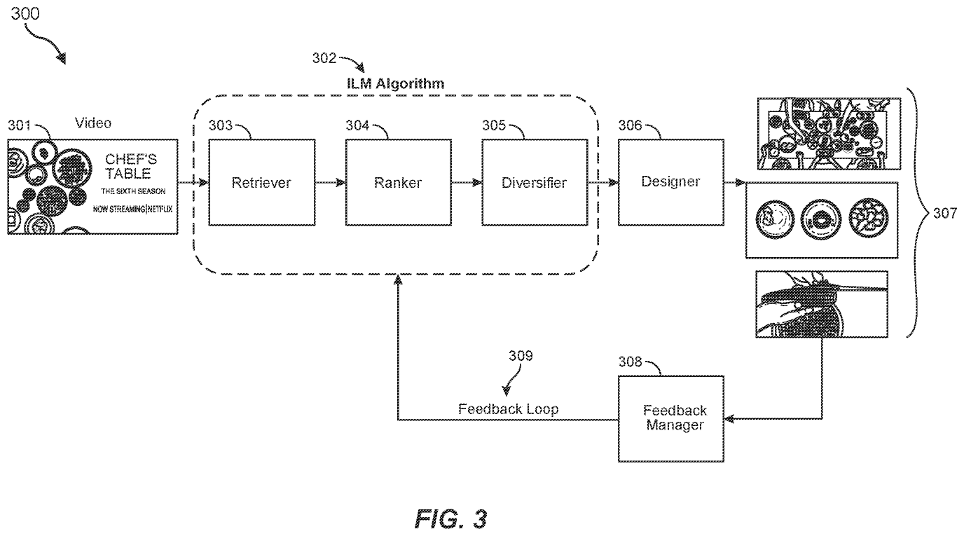

FIG. 3 illustrates a computing architecture 300 in which the method 200 may operate. In the computing architecture 300, a retriever 303 may be configured to access various images. In the example of FIG. 3, the retriever 303 may be configured to access images from a video 301 entitled “Chef's Table.” The retriever 303 may additionally access multiple other images and associated take fractions that are based on other media items that have previously been analyzed. The previous analysis may indicate, for each image, how well that image performed at getting users to select and view the media item. Those image and take fraction pairs may be used by the ranker 304 to train an ML model to recognize which images are most likely to perform well at drawing views. The ML model may be trained to recognize which patterns lead to higher image take fractions (e.g., patterns showing a main character, or patterns showing a specific genre or style (action or western), or patterns showing an overall tone of the media item, or other types of patterns). The ranker 304 may then use this trained ML model to analyze the images received from the video 301 and rank the images based on their calculated take fraction.

The diversifier 305 may then access the ranked images and determine which type of images are present in the ranked list. In some cases, the highest ranked images from a video (e.g., 301) may align with different categories or thematic elements. The diversifier 305 may be configured to separate the images into these different categories or thematic elements. In some cases, the diversifier 305 may be configured to ensure that each category has a specified minimum amount (i.e., a budget) of images placed therein. This, in turn, ensures that each media item has a wide range of different thematic types of images that could potentially be used as storyart. By having multiple thematic categories (e.g., most prominent character, tone (upbeat), genre (action), setting, etc.), each category may have at least one highly ranked image that could be used as storyart to highlight that aspect of the media item. Then, if a user known to like action movies or known to like dramas is viewing a media item selection user interface (UI), the storyart appropriate for that user may be pulled from the corresponding thematic container and may be used to attract the user's attention and persuade them to select and stream that media item. Having many different highly ranked images may increase the chances of finding an image that causes a specific user to select the video or TV show based on a targeted storyart image that was selected and displayed specifically for that user.

In some cases, the image learning model (ILM) algorithm 302 may be implemented to select images for storyart. In other cases, the ILM algorithm 302 may output an image to a designer 306. The designer may be a human user who looks at the various ranked images in the different thematic containers and chooses which images should be used as storyart for the video 301. In some cases, the designer 306 may be aware of which thematic container each image is assigned to (in some cases, images can be assigned to more than one container), and in other cases, the designer may not be aware of which thematic container each image is assigned to. In the latter case, the designer 306 may pick images which they deem to be most likely to draw views and may be presented images from different containers by the ILM algorithm (302).

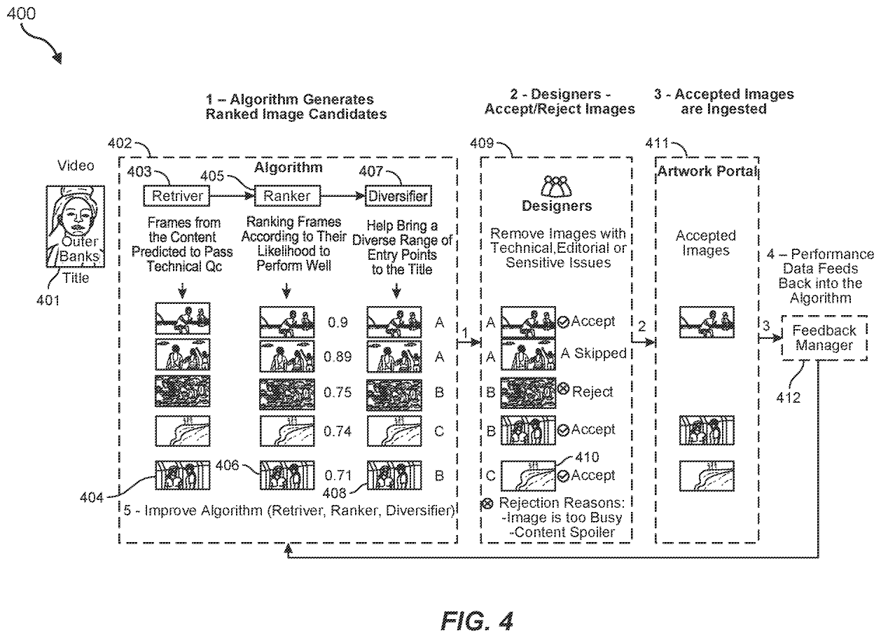

After the designer 306 or the ILM algorithm 302 selects storyart images 307 for the video 301, the selected images may be passed to the streaming video selection UI, as well as to a feedback manager 308. The feedback manager 308 may track which images are used as storyart associated with video 301 and may track which images resulted in the most views of video 301. This information may then be used as feedback in a feedback loop 309. The feedback may indicate which storyart images 307 performed the best at driving views. This indication may then be used to identify patterns in the top-performing storyart images and dynamically update the ML model to better recognize which storyart images will lead to the most views. This process is illustrated in further detail in FIG. 4.

FIG. 4 illustrates a different media item 401 that is provided to the ILM algorithm 402. As in FIG. 3, the ILM algorithm in FIG. 4 includes a retriever 403, a ranker 405, and a diversifier 407. In this embodiment, the retriever 403 analyzes each (or at least some) of the image frames in the media item and selects those that are predicted to pass technical quality control. This technical quality control may remove images that are blurry or are too dark or include sensitive subject matter or are otherwise unsuitable for use as storyart. In some embodiments, the retriever 403 may access image frames that have already passed quality control, and, in other embodiments, the retriever may access image frames 404 that are predicted to pass quality control but have not yet been analyzed and filtered by quality control. Those images 404 that are predicted to pass quality control may then be provided to the ranker 405.

The ranker 405 may receive the images 404 from the retriever 403 that have either passed quality control or have been predicted to pass quality control. The ranker 405 may rank the received images based on their likelihood to perform well at driving views to the media item 401. As noted above, the ranker 405 may, itself, be a machine learning model, inferential model, deep learning model, a neural network, or other similar type of model, or may have access to such a model running on a different platform or computing system. These models may include special-purpose processors, including machine learning processors. An ML processor, for example, may be a dedicated, special-purpose processor with logic and circuitry designed to perform machine learning. The ML processor may work in tandem with a feedback implementation module to access data and use feedback to train an ML model. For instance, the ML processor may access one or more different training data sets. The ML processor and/or the feedback implementation module may use these training data sets to iterate through positive and negative samples and improve the ML model over time.

In some cases, the machine learning model may include an inferential model. As used herein, the term “inferential model” may refer to purely statistical models, purely machine learning models, or any combination of statistical and machine learning models. Such inferential models may include neural networks such as recurrent neural networks. In some embodiments, the recurrent neural network may be a long short-term memory (LSTM) neural network. Such recurrent neural networks are not limited to LSTM neural networks and may have any other suitable architecture. For example, in some embodiments, the neural network may be a fully recurrent neural network, a gated recurrent neural network, a recursive neural network, a Hopfield neural network, an associative memory neural network, an Elman neural network, a Jordan neural network, an echo state neural network, a second order recurrent neural network, and/or any other suitable type of recurrent neural network. In other embodiments, neural networks that are not recurrent neural networks may be used. For example, deep neural networks, convolutional neural networks, and/or feedforward neural networks, may be used. In some implementations, the inferential model may be an unsupervised machine learning model, e.g., where previous data (on which the inferential model was previously trained) is not required.

At least some of the embodiments described herein may include training a neural network to identify data dependencies, identify which information from various data sources is to be altered to lead to a desired outcome or how to alter the information to lead to a desired outcome. In some embodiments, the systems described herein may include a neural network that is trained to identify how information is to be altered using different types of data and associated data dependencies. For example, the embodiments herein may use a feed-forward neural network. In some embodiments, some or all of the neural network training may happen offline. Additionally or alternatively, some of the training may happen online. In some examples, offline development may include feature and machine learning model development, training, and/or test and evaluation.

Once the machine learning model has been trained, the ML model may be used to identify which data is to be altered and how that data is to be altered based on multiple different data sets. In some embodiments, the machine learning model that makes these determinations may be hosted on different cloud-based distributed processors (e.g., ML processors) configured to perform the identification in real time or substantially in real time. Such cloud-based distributed processors may be dynamically added, in real time, to the process of identifying data alterations. These cloud-based distributed processors may work in tandem with a prediction module to generate outcome predictions, according to the various data inputs.

These predictions may identify potential outcomes that would result from the identified data alterations. The predictions output by the prediction module may include associated probabilities of occurrence for each prediction. The prediction module may be part of a trained machine learning model that may be implemented using the ML processor. In some embodiments, various components of the machine learning module may test the accuracy of the trained machine learning model using, for example, proportion estimation. This proportion estimation may result in feedback that, in turn, may be used by the feedback implementation module in a feedback loop to improve the ML model and train the model with greater accuracy.

Thus, regardless of which type of machine learning or other model is used, the ILM algorithm 402 may train using past data. The past data, in this implementation, may include other images that were taken from underlying media items and used as storyart for those media items. The storyart images may then be provided in a streaming platform media selection UI where users can select media items for streaming. The system may then track how well each of the images fared as storyart by tracking how many times the corresponding media items were selected. The tracking may also note the amount of time each media item was streamed.

In some cases, a “successful” stream may be one of at least a minimum length (e.g., >15 minutes, >20 minutes, >30 minutes). In other cases, the minimum length may not be used or may be smaller (e.g., 5 min.). In some cases, a “successful” stream may be based on the proportion of the media item watched (e.g., 20% of the duration of the media title, 50% of the duration of the media title, 70% of the duration of the media title, etc.). Those images that fared the best may be analyzed for patterns. These patterns may include colors, shapes, objects, positions, the proportions of storyart elements, or any combination thereof that would lend that image to attract interest for the underlying media item. The ILM algorithm 402 may then note these patterns and apply the patterns when analyzing images from the retriever 403 for media item 401. At least in some cases, the analysis results in a predicted image take fraction for each image, indicating the predicted percentage of likely views per number of impressions.

After analyzing the images 404, the ranker may be configured to rank the images based on their calculated take fraction. In FIG. 4, the images 406 are ranked from highest to lowest, with predicted image take fractions of 0.9, 0.89, 0.75, 0.74, and 0.71. The ranked images 406 are then provided to the diversifier 407. The diversifier 407 may be configured to provide a diverse range of storyart images for each media item. At least in some cases, it may be advantageous to have different storyart images to present to different users. Thus, if a user has shown a proclivity in the past to watch films with a certain actor or actress, a storyart image with that actor or actress may be the best hook for the media item 401 for that particular user. Other users may be attracted to different aspects of the media item 401. Thus, the diversifier 407 may group the images 408 into different thematic containers (A, B, and C in this case).

The ILM algorithm 402 may then pass the ranked and grouped images to one or more designers 409 who can either accept or reject the images as storyart. The accepted images 410 may be passed to an artwork portal 411 for minor edits and/or final review, while rejected images may be discarded, potentially along with an indication of why the images were not used (e.g., the image is too busy or contains a spoiler about the media item or contains sensitive content, etc.). The accepted and rejected images may then be provided to a feedback manager 412 that notes the outcome of each image. This information may be implemented by the feedback manager 412 to inform the ILM algorithm 402, which can use the image acceptances or rejections in its future pattern matching analyses.

In this manner, the ILM algorithm at (1) may generate ranked image candidates, (2) designers may accept or reject the proposed images, (3) accepted images may be used in the artwork portal and provided to a streaming platform's UI, for example, (4) performance data (e.g., take fraction) feeds back into the ILM algorithm, and (5) each aspect of the ILM algorithm (retriever, ranker, and diversifier) may learn and improve based on the identified performance data. Thus, the system may continually improve over time and may achieve higher and higher take fractions for each new storyart image.

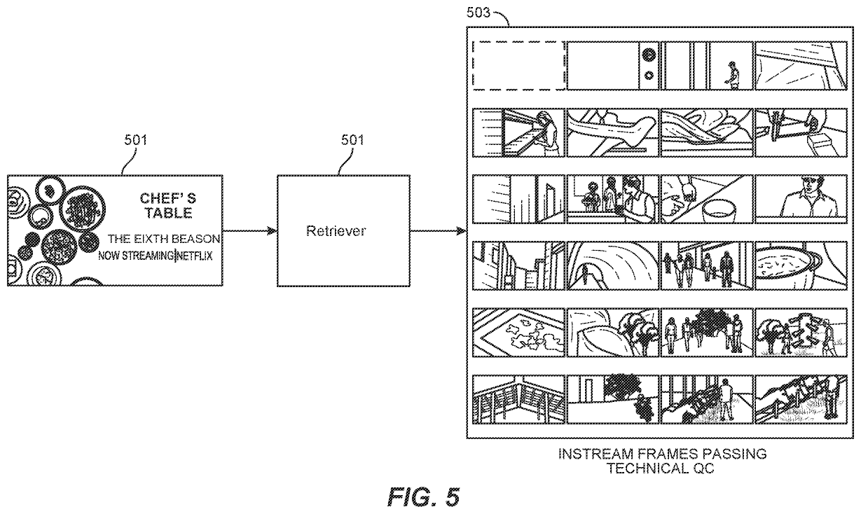

FIGS. 5-11 illustrate various embodiments showing how the retriever, the ranker, and the diversifier may perform their intended functions. FIG. 5, for example, shows how a retriever 502 may access various image frames from a media item 501. In some cases, the retriever 502 may access all of the image frames 503 corresponding to the media item 501 and may perform technical quality control to filter out those images that are too dark, too close, too abstract, too blurry, or otherwise unsuitable for use as storyart to represent the media item 501. Alternatively, the technical quality control may have already been performed, and the retriever 502 may access those images 503 that have already passed technical quality control and are, thus, deemed to be suitable for use as storyart.

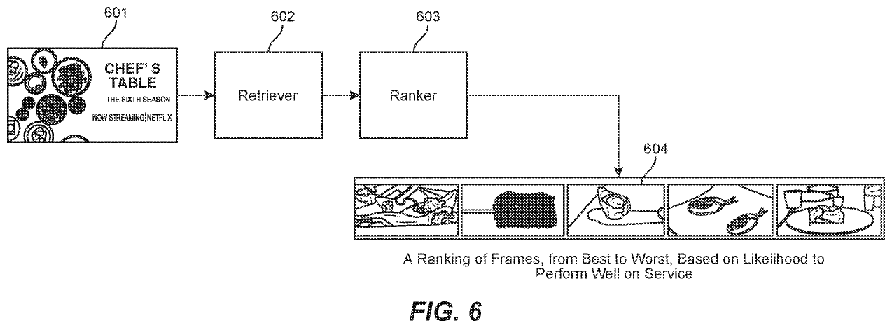

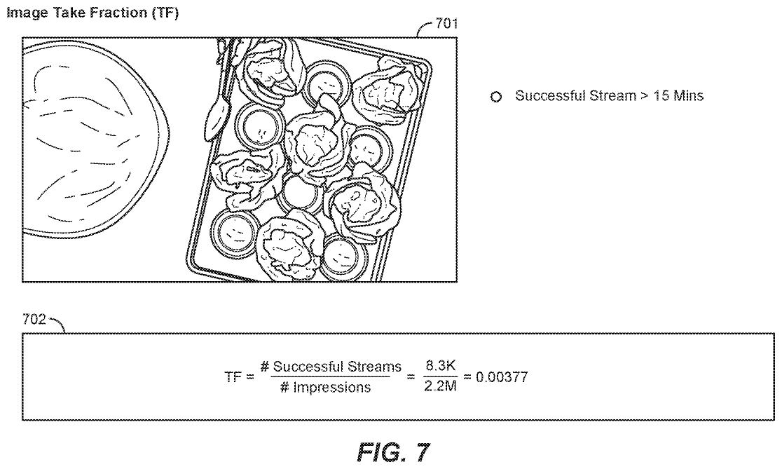

FIG. 6 illustrates an embodiment in which the ranker 603 may receive suitable images from the retriever 602 that correspond to an underlying media item 601. The ranker may rank the received frames from best to worst, based on which image frames are most likely to perform well on a streaming platform service (e.g., which will have the highest take fraction). For instance, as shown in FIG. 7, the take fraction (TF) 702 may represent the number of successful streams divided by the number of impressions (e.g., the number of people that view the storyart image 701). In the example of FIG. 7, the number of successful streams (meaning plays >15 minutes, in this case) is 8.3K and the number of impressions is 2.2M. This results in an image take fraction 702 of 0.00377. Returning to FIG. 6, the ranker 603 may calculate an image take fraction for each image and then rank the images 604 from the highest take fraction to the lowest take fraction. This determined take fraction for storyart image 701 may be a prediction based on patterns that are identified by an ML model. As noted above, the number of successful streams may be replaced with the number of likes, the number of shares, the number of repeat viewings, or other indicators of interest in the media item relative to the number of impressions.

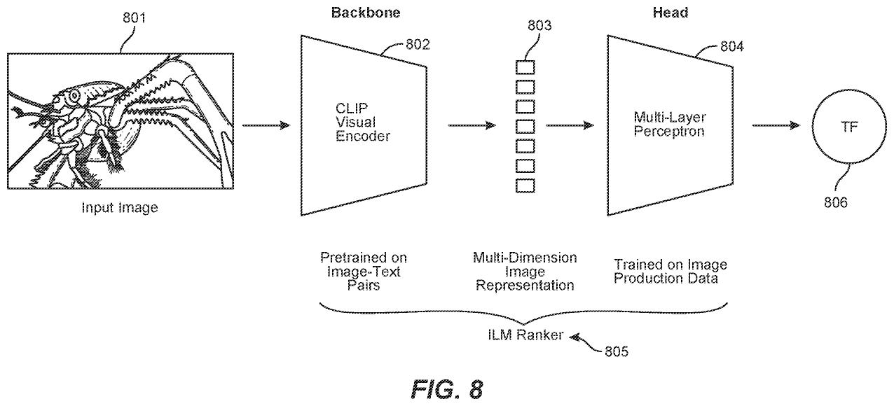

FIG. 8 illustrates an embodiment in which an ML model is trained to predict an image take fraction for an input image 801. The input image 801 may be taken from a movie, TV show, or other media item. The input image 801 (which, prior to processing by the ILM algorithm, may be unprocessed by the system) may be processed by a visual encoder 802. The visual encoder may be pretrained on many millions (or more) of image-text pairs that link an image to various patterns. These patterns may include multiple different dimensions (e.g., 768 dimensions) that represent the content, context, characters, tone, or other aspects or characteristics of an image. At 803, these different dimensions and aspects of the image may be identified and associated with the image, potentially in the form of metadata. The image may also be processed by a multi-layer perceptron module at 804. This multi-layer perceptron may be trained on image production data that links storyart images to their underlying media items and indicates how well the storyart has performed at drawing views to the media item.

Each module or component of the ILM ranker 805 (e.g., 802, 803, 804) may be used to determine, in part or in whole, the image take fraction 806 for the input image 801. This image take fraction 806 may then be accessed by the ranker and used to rank the images based on their potential to perform well as storyart. In some cases, the ILM ranker 805 may, itself, be or may include a deep learning model that is configured to analyze multiple different images and corresponding predetermined image take fractions to predict how well the input image 801 will correlate to views of the input image 801. The ILM ranker 805 may then rank each of the images based on the predicted image take fractions. In some cases, the image take fraction 806 may be based on other factors that are additional to the number of quality views and the number of impressions.

For instance, in some embodiments, the ranker 805 may also implement, as a factor for determining the image take factor 806, an amount of time spent watching the media item. If the amount of time is too little (i.e., it is below a threshold minimum amount), that view may not count toward the number of quality views. In other cases, the ILM ranker 805 may additionally or alternatively use title-level metadata or other properties as factors when determining the image take fraction 806. The title-level metadata, for example, may include genre, storyline, tone, or other information about a media item. Some genres, for instance, may lend themselves to certain types of audiences, and some storyart images may resonate more with viewers of that genre. As such, the ILM ranker 805 may be configured to determine at least one genre for an input image (e.g., 801) and use that genre, as a factor, when predicting how well that image will perform as storyart.

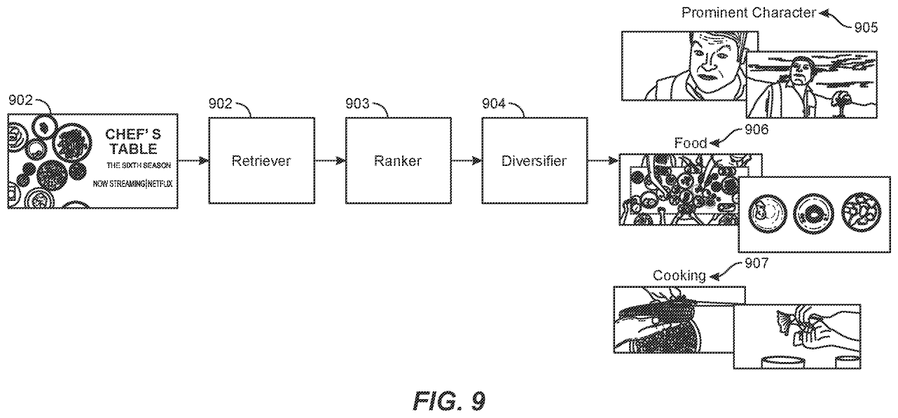

After the images have been filtered for quality control and have been ranked according to their predicted image take factor, the diversifier may group the ranked images into thematic containers. Thus, as shown in FIG. 9, images from an underlying media item 901 may be retrieved (902), ranked (903), and then diversified (904). In some cases, the thematic containers may be metadata tags or labels, while in other cases, the containers may be physically separate data stores. These thematic containers may be designed to include all different types of images. The thematic containers may be different for different media items or may be uniform across most or all images.

In some cases, designers can create their own thematic containers, and in some cases, a single image may belong to more than one container. In one non-limiting embodiment, the thematic containers may include: images with specific characters, images conveying specific genres, images conveying specific storylines, images conveying specific tones, or images conveying a specific type of shot. FIG. 9 illustrates three thematic containers that apply to the media item 901: images with prominent characters 905, images with food objects 906, and images that illustrate cooking 907. Other thematic containers may also be used in conjunction with media item 901.

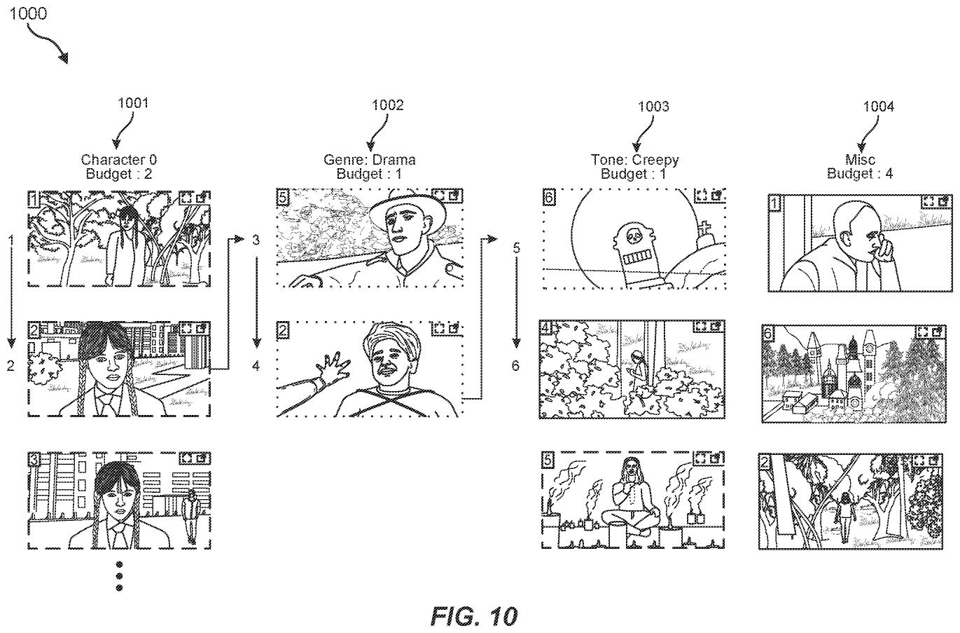

In some cases, a supervised model may be implemented to group the ranked images into thematic containers. The supervised model may establish or work with minimum specified amounts of images that are to be assigned to each thematic container. For instance, in some cases, each thematic bucket may be assigned a specific number of images that are to be taken from the associated media item and placed into that media item's thematic containers. In FIG. 10, for example, four thematic containers 1000 may be established for a media item entitled “Wednesday.” These thematic containers may include character (1001), genre: drama (1002), tone: creepy (1003), and miscellaneous (1004). The character container 1001 may have a budget of at least two images, the genre container 1002 may have a budget of at least one image, the tone container 1003 may have a budget of at least one image, and the miscellaneous container 1004 may have a budget of at least four images. These budget numbers are arbitrary and may change in different embodiments. The diversifier 904 of FIG. 9 may ensure that each thematic container receives its specified minimum amount (i.e., budget) of images.

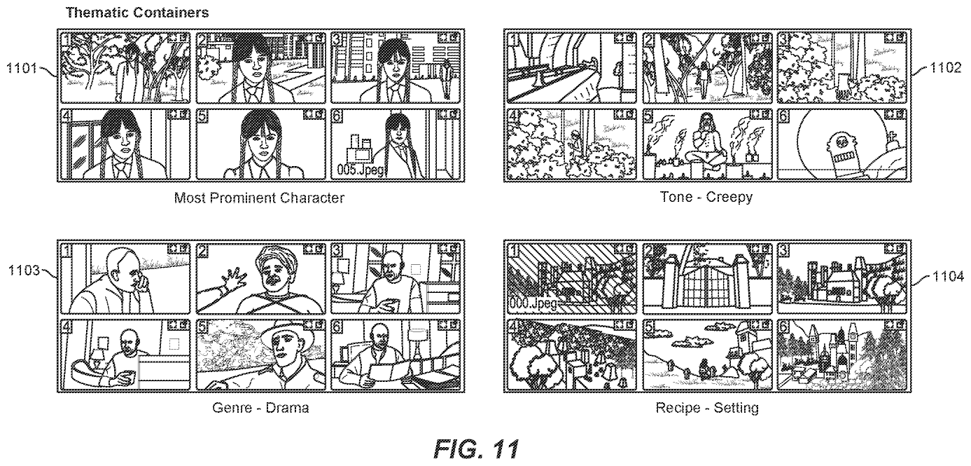

Within each thematic container, the images may be ranked based on the image's corresponding image take fraction. For example, in FIG. 11, the images in the “Most Prominent Character” container 1101 may be ranked with the image having the highest take fraction being placed in the top left box, while the image having the lowest image take fraction may be placed in the bottom right box. Similarly, the images in the “Tone-Creepy” container 1102, the images in the “Genre-Drama” container 1103, and the images in the “Recipe-Setting” container 1104 may be similarly ranked with the highest-ranking image in the top left and the lowest-ranking image in the bottom right. These collections of images may then be presented to users, such as designers, for selection and use with the associated media item. Upon presentation, the users may be able to see, at a glance, which images were predicted to perform the best in each thematic container. This knowledge may then inform the user when making their selections for storyart images.

In some embodiments, the ranker (e.g., 903) may be configured to identify patterns, characteristics, features, objects, shapes, or other items in an image. The identification of such features in storyart images allows the ranker 903 to quickly and efficiently select numerous images that are predicted to perform well at drawing views. In at least some cases, user interfaces tools may be provided that allow users to view and/or select storyart images identified by the ranker. This process may greatly reduce the amount of time and effort used in finding and implementing storyart images in media streaming interfaces.

Because the ranker 903 can evaluate millions of past images and identify commonalities between images that performed well across many different types of movies and TV shows, the ranker can use those patterns and characteristics to quickly and efficiently identify optimal storyart images for new media items. These patterns also allow the diversifier 904 to distinguish between movies that may both have similar (e.g., dark) themes, but have different tones (e.g., dark comedy vs. horror). The diversifier 904 may be configured to identify differences in characters, shots, scenes, backgrounds, objects, or other items that allow the diversifier to determine an overall tone for a media item and to classify images from that media item accordingly. In some cases, the diversifier 904 may additionally or alternatively look at image metadata when determining tone and/or when assigning images to different thematic containers. The image metadata may indicate information about the media item, information about corresponding audio, subtitle information, or other information that would inform the diversifier 904 on how to group the images received from the ranker 903.

In some cases, the ILM algorithm, including the retriever 902, the ranker 903, and the diversifier 904 may be configured to work with different versions of the same image or even with computer-generated images. These different types of images or different versions of the same image (e.g., cropped to include or exclude certain characters or objects, or processed to move the subject relative to the background, or processed to change the background to a less distracting background, or processed to add lens blur, etc.) may be analyzed by the ILM algorithm, ranked based on projected image take fraction, and categorized into different, ranked thematic containers. Recropped versions of an image or computer-generated images may result in different image take fractions for the underlying media item. As such, the ILM algorithm may be configured to process the recropped or computer-generated versions of the image as separate images that are each associated with the media item. Thus, each image crop for the same underlying image may be independently analyzed, scored, ranked, and categorized.

Similarly, if a user edits an image after it has been scored, the ranker may reprocess the image after the edits. Then, with the new image take fraction for the edited image, the diversifier may recategorize the edited image and provide it to the appropriate thematic container(s) where the image can be used as storyart for the media item. Still further, because the ILM may be continually subjected to feedback and learning based on how past predictions fared in real-world environments, the ILM may be configured to either automatically select new storyart images based on a current image's poor performance or may prompt a user to select a new storyart image while indicating that the current image is faring poorer than initially projected. In this manner, the ILM algorithm may continually improve not only its own calculations regarding image take fraction, but may also ensure, on a regular basis, that the optimal images are presented in a streaming service's media item selection user interface.

In addition to the computer-implemented method described above, a corresponding system may be provided that includes: at least one physical processor and physical memory including computer-executable instructions that, when executed by the physical processor, cause the physical processor to: access at least one image associated with a media item, identify an association between the accessed image and an image take fraction that indicates how well the accessed image correlates to views of the associated media item, based at least on the identified association between the accessed media item image and the corresponding image take fraction, train a machine learning (ML) model to predict which images will optimally correlate to views of the associated media item, access an unprocessed image associated with a new media item that has not been processed by the trained ML model, and implement the trained ML model to predict an image take fraction for the unprocessed image to indicate how well the unprocessed image will correlate to views of the new, unprocessed media item.

Still further, in addition to the computer-implemented method described above, a non-transitory computer-readable medium may be provided that includes computer-executable instructions that, when executed by at least one processor of a computing device, cause the computing device to: access at least one image associated with a media item, identify an association between the accessed image and an image take fraction that indicates how well the accessed image correlates to views of the associated media item, based at least on the identified association between the accessed media item image and the corresponding image take fraction, train a machine learning (ML) model to predict which images will optimally correlate to views of the associated media item, access an unprocessed image associated with a new media item that has not been processed by the trained ML model, and implement the trained ML model to predict an image take fraction for the unprocessed image to indicate how well the unprocessed image will correlate to views of the new, unprocessed media item.

### EXAMPLE EMBODIMENTS

Example 1. A computer-implemented method comprising: accessing at least one image associated with a media item, identifying an association between the accessed image and an image take fraction that indicates how well the accessed image correlates to views of the associated media item, based at least on the identified association between the accessed media item image and the corresponding image take fraction, training a machine learning (ML) model to predict which images will optimally correlate to views of the associated media item, accessing an unprocessed image associated with a new media item that has not been processed by the trained ML model, and implementing the trained ML model to predict an image take fraction for the unprocessed image to indicate how well the unprocessed image will correlate to views of the new, unprocessed media item.

Example 2. The computer-implemented method of Example 1, wherein the ML model is configured to identify one or more patterns in the unprocessed image and match those identified patterns to patterns associated with the accessed image.

Example 3. The computer-implemented method of Example 1 or Example 2, further comprising filtering images that are to be processed by the ML model to ensure that the images are usable by the ML model.

Example 4. The computer-implemented method of any of Examples 1-3, wherein the image take fraction indicates a percentage of views of the associated media item relative to a number of impressions of the accessed image.

Example 5. The computer-implemented method of any of Examples 1-4, wherein the ML model comprises a deep learning model that is configured to analyze a plurality of images and a corresponding plurality of image take fractions to indicate how well the plurality of images correlates to views of the associated media items.

Example 6. The computer-implemented method of any of Examples 1-5, further comprising ranking each of the plurality of images based on the predicted image take fractions.

Example 7. The computer-implemented method of any of Examples 1-6, wherein the image take fraction includes, as a factor, an amount of time spent watching the media item.

Example 8. The computer-implemented method of any of Examples 1-7, wherein the image take fraction includes, as a factor, a genre associated with the media item.

Example 9. The computer-implemented method of any of Examples 1-8, wherein recropped versions of the accessed image result in different image take fractions for the associated media item.

Example 10. The computer-implemented method of any of Examples 1-9, wherein the ML model is configured to process the recropped versions of the accessed image as separate images that are each associated with the media item.

Example 11. The computer-implemented method of any of Examples 1-10, further comprising: tracking, as feedback, how well the unprocessed image correlated to views of the associated media item; and incorporating the feedback in the ML model when accessing future images and predicting future image take fractions.

Example 12. The computer-implemented method of any of Examples 1-11, further comprising changing an artwork image for at least one media item based on the incorporated feedback.

Example 13. A system comprising: at least one physical processor; and physical memory comprising computer-executable instructions that, when executed by the physical processor, cause the physical processor to: access at least one image associated with a media item; identify an association between the accessed image and an image take fraction that indicates how well the accessed image correlates to views of the associated media item; based at least on the identified association between the accessed media item image and the corresponding image take fraction, train a machine learning (ML) model to predict which images will optimally correlate to views of the associated media item; access an unprocessed image associated with a new media item that has not been processed by the trained ML model; and implement the trained ML model to predict an image take fraction for the unprocessed image to indicate how well the unprocessed image will correlate to views of the new, unprocessed media item.

Example 14. The system of Example 13, wherein the unprocessed image and other images processed by the ML model are ranked based on the corresponding predicted image take fractions, and wherein a supervised model is implemented to group the ranked images into thematic containers.

Example 15. The system of Example 13 or Example 14, wherein each thematic bucket is assigned a specific number of images that are to be taken from the associated media item and placed in each thematic container.

Example 16. The system of any of Examples 13-15, wherein the thematic containers include containers for at least one of: images with specific characters, images conveying specific genres, images conveying specific storylines, images conveying specific tones, or images conveying a specific type of shot.

Example 17. The system of any of Examples 13-16, wherein at least one of the images belongs to a plurality of different thematic containers.

Example 18. The system of any of Examples 13-17, wherein the images in each thematic container are ranked based on the image's corresponding image take fraction.

Example 19. The system of any of Examples 13-18, further comprising presenting the images in the thematic containers to at least one user for selection and use with the associated media item.

Example 20. A non-transitory computer-readable medium comprising one or more computer-executable instructions that, when executed by at least one processor of a computing device, cause the computing device to: access at least one image associated with a media item; identify an association between the accessed image and an image take fraction that indicates how well the accessed image correlates to views of the associated media item; based at least on the identified association between the accessed media item image and the corresponding image take fraction, train a machine learning (ML) model to predict which images will optimally correlate to views of the associated media item; access an unprocessed image associated with a new media item that has not been processed by the trained ML model; and implement the trained ML model to predict an image take fraction for the unprocessed image to indicate how well the unprocessed image will correlate to views of the new, unprocessed media item.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
accessing at least one image associated with a media item;
identifying an association between the accessed image and an image take fraction that indicates how well the accessed image correlates to views of the associated media item;
based at least on the identified association between the accessed media item image and the corresponding image take fraction, training a machine learning (ML) model to predict which images will optimally correlate to views of the associated media item;
accessing an unprocessed image associated with a new media item that has not been processed by the trained ML model; and
implementing the trained ML model to predict an image take fraction for the unprocessed image to indicate how well the unprocessed image will correlate to views of the new, unprocessed media item.

2. The computer-implemented method of claim 1, wherein the ML model is configured to identify one or more patterns in the unprocessed image and match those identified patterns to patterns associated with the accessed image.

3. The computer-implemented method of claim 1, further comprising filtering images that are to be processed by the ML model to ensure that the images are usable by the ML model.

4. The computer-implemented method of claim 1, wherein the image take fraction indicates a percentage of views of the associated media item relative to a number of impressions of the accessed image.

5. The computer-implemented method of claim 1, wherein the ML model comprises a deep learning model that is configured to analyze a plurality of images and a corresponding plurality of image take fractions to indicate how well the plurality of images correlates to views of the associated media items.

6. The computer-implemented method of claim 5, further comprising ranking each of the plurality of images based on the predicted image take fractions.

7. The computer-implemented method of claim 1, wherein the image take fraction includes, as a factor, an amount of time spent watching the media item.

8. The computer-implemented method of claim 1, wherein the image take fraction includes, as a factor, a property associated with the media item.

9. The computer-implemented method of claim 1, wherein recropped versions of the accessed image result in different image take fractions for the associated media item.

10. The computer-implemented method of claim 9, wherein the ML model is configured to process the recropped versions of the accessed image as separate images that are each associated with the media item.

11. The computer-implemented method of claim 1, further comprising:
tracking, as feedback, how well the unprocessed image correlated to views of the associated media item; and
incorporating the feedback in the ML model when accessing future images and predicting future image take fractions.

12. The computer-implemented method of claim 11, further comprising changing an artwork image for at least one media item based on the incorporated feedback.

13. A system comprising:
at least one physical processor; and
physical memory comprising computer-executable instructions that, when executed by the physical processor, cause the physical processor to:
access at least one image associated with a media item;
identify an association between the accessed image and an image take fraction that indicates how well the accessed image correlates to views of the associated media item;
based at least on the identified association between the accessed media item image and the corresponding image take fraction, train a machine learning (ML) model to predict which images will optimally correlate to views of the associated media item;
access an unprocessed image associated with a new media item that has not been processed by the trained ML model; and
implement the trained ML model to predict an image take fraction for the unprocessed image to indicate how well the unprocessed image will correlate to views of the new, unprocessed media item.

14. The system of claim 13, wherein the unprocessed image and other images processed by the ML model are ranked based on the corresponding predicted image take fractions, and wherein a supervised model is implemented to group the ranked images into thematic containers.

15. The system of claim 14, wherein each thematic bucket is assigned a specific number of images that are to be taken from the associated media item and placed in each thematic container.

16. The system of claim 14, wherein the thematic containers include containers for at least one of: images with specific characters, images conveying specific genres, images conveying specific storylines, images conveying specific tones, or images conveying a specific type of shot.

17. The system of claim 14, wherein at least one of the images belongs to a plurality of different thematic containers.

18. The system of claim 14, wherein the images in each thematic container are ranked based on the image's corresponding image take fraction.

19. The system of claim 14, further comprising presenting the images in the thematic containers to at least one user for selection and use with the associated media item.

20. A non-transitory computer-readable medium comprising one or more computer-executable instructions that, when executed by at least one processor of a computing device, cause the computing device to:
access at least one image associated with a media item;
identify an association between the accessed image and an image take fraction that indicates how well the accessed image correlates to views of the associated media item;
based at least on the identified association between the accessed media item image and the corresponding image take fraction, train a machine learning (ML) model to predict which images will optimally correlate to views of the associated media item;
access an unprocessed image associated with a new media item that has not been processed by the trained ML model; and
implement the trained ML model to predict an image take fraction for the unprocessed image to indicate how well the unprocessed image will correlate to views of the new, unprocessed media item.
